(19) United States
(12) Patent Application Publication
(10) Pub. No.: US 2024/0039580 A1
(43) Pub. Date: Feb. 1, 2024

(54) MAGNETIC SIGNAL RECEIVING DEVICE AND MAGNETIC FIELD COMMUNICATION SYSTEM

(71) Applicant: ELECTRONICS AND TELECOMMUNICATIONS RESEARCH INSTITUTE, Daejeon (KR)

(72) Inventors: Jang Yeol KIM, Daejeon (KR); Jung Hoon OH, Daejeon (KR); Jaeho LEE, Sejong-si (KR); Hyunjoon LEE, Sejong-si (KR); In Kui CHO, Sejong-si (KR)

(73) Assignee: ELECTRONICS AND TELECOMMUNICATIONS RESEARCH INSTITUTE, Daejeon (KR)

(21) Appl. No.: 18/335,697

(22) Filed: Jun. 15, 2023

(30) Foreign Application Priority Data
Jul. 26, 2022 (KR) 10-2022-0092276
Mar. 6, 2023 (KR) 10-2023-0029370

(51) Int. Cl. H04B 5/00; H01F 38/14

(52) U.S. Cl. CPC H04B 5/0081; H01F 38/14; H01F 2038/143

(57) ABSTRACT

A magnetic signal receiving device and a magnetic field communication system are disclosed. The magnetic signal receiving device includes a signal detector including a magnetic sensor and configured to detect a magnetic signal using the magnetic sensor, a signal amplifier configured to amplify the magnetic signal detected by the signal detector, and a demodulator configured to restore the amplified magnetic signal received from the signal amplifier into an original signal.

### CROSS-REFERENCE TO RELATED APPLICATIONS

This application claims the benefit of Korean Patent Application No. 10-2022-0092276 filed on Jul. 26, 2022, Korean Patent Application No. 10-2023-0029370 filed on Mar. 6, 2023, in the Korean Intellectual Property Office, the entire disclosures of which are incorporated herein by reference for all purposes.

### BACKGROUND

### 1. Field of the Invention

One or more embodiments relate to a magnetic signal receiving device and a magnetic field communication system.

### 2. Description of the Related Art

Magnetic field communication technology is a wireless communication system using a magnetic field and may perform wireless communication even in extreme environments such as metal, underwater, underground, and collapsed buildings.

Magnetic field communication technology corresponds to next-generation wireless communication technology to solve weaknesses of the existing radio-frequency identification (RFID) technology and ubiquitous sensor network (USN) technology and to expand the application range of wireless communication technology.

Since magnetic field communication technology uses a low-frequency unlike commonly used high-frequency communication technology, this technology has high permeability and low propagation loss even though a wireless signal passes through different media such as soil, water, and concrete.

In addition, magnetic field communication technology has a much wider communication range than near field communication (NFC) and RFID using a low-frequency and is easy to implement low power, so this technology is suitable for constructing a sensor network system for monitoring and management of underground or underwater environments.

### SUMMARY

Embodiments provide a magnetic field communication method and a device that may communicate at medium to long distances. According to various embodiments, magnetic field communication using a magnetic signal may be performed using a differential magnetic receiving sensor and a differential magnetic sensor-based receiver.

Embodiments provide a magnetic field communication method and device for medium to long distances that may improve the performance of a magnetic sensor and a receiver and perform magnetic field communication at medium to long distances using a resonant magnetic receiving sensor and a resonant magnetic sensor-based receiver.

According to an aspect, there is provided a device for receiving a magnetic signal, the device including a signal detector including a magnetic sensor and configured to detect a magnetic signal using the magnetic sensor, a signal amplifier configured to amplify the magnetic signal detected by the signal detector, and a demodulator configured to restore the amplified magnetic signal received from the signal amplifier into an original signal.

The magnetic sensor may include a ferromagnetic core and a pickup coil wound around the ferromagnetic core and is configured to convert a magnetic signal detected through the pickup coil into an induced voltage and output the induced voltage.

The magnetic sensor may include a first ferromagnetic core, a second ferromagnetic core, a first pickup coil wound around the first ferromagnetic core, and a second pickup coil wound around the second ferromagnetic core, is configured to convert the magnetic signal detected through the first pickup coil into a first induced voltage and output the first induced voltage, and is configured to convert the magnetic signal detected through the second pickup coil into a second induced voltage and output the second induced voltage.

The signal amplifier may be configured to configured to amplify and output a difference between the first induced voltage and the second induced voltage using a differential amplifier.

The second pickup coil may be configured to convert the magnetic signal into the second induced voltage having the same magnitude as a magnitude of the first induced voltage and a phase opposite to a phase of the first induced voltage.

The device may further include a matching circuit configured to control a resonant frequency of the magnetic sensor.

According to an aspect, there is provided a device for receiving a magnetic signal including a signal detector configured to convert a magnetic signal detected using a differential magnetic sensor into a first induced voltage and a second induced voltage, a signal amplifier configured to output an amplified signal obtained by amplifying a difference between the first induced voltage and the second induced voltage using a differential amplifier, and a demodulator configured to extract and restore a message signal using the amplified signal.

The differential magnetic sensor may include a first ferromagnetic core, a second ferromagnetic core, a first pickup coil wound around the first ferromagnetic core, and a second pickup coil wound around the second ferromagnetic core, is configured to convert the magnetic signal detected through the first pickup coil into the first induced voltage and output the first induced voltage, and is configured to convert the magnetic signal detected through the second pickup coil into the second induced voltage and output the second induced voltage.

The second induced voltage may have the same magnitude as a magnitude of the first induced voltage and a phase opposite to a phase of the first induced voltage.

The signal amplifier may include a first signal amplifier configured to amplify and output the difference between the first induced voltage and the second induced voltage and a second signal amplifier configured to amplify a signal output from the first signal amplifier and output the amplified signal.

The second signal amplifier may include a third signal amplifier and a fourth signal amplifier each including a filter. The third signal amplifier and the fourth signal amplifier may be cascaded.

According to an aspect, there is provided a system for communicating a magnetic field, the system including a magnetic signal transmission device configured to modulate an original signal into a modulated signal and transmit the modulated signal into a magnetic signal and a magnetic signal receiving device configured to detect the magnetic signal using a magnetic sensor, output an amplified signal obtained by amplifying the detected magnetic signal, and restore the original signal using the amplified signal.

The magnetic signal receiving device may include a signal detector including the magnetic sensor and configured to detect the magnetic signal using the magnetic sensor, a signal amplifier configured to amplify the detected magnetic signal and output the amplified signal, and a demodulator configured to restore the original signal using the amplified signal.

The magnetic sensor may include a ferromagnetic core and a pickup coil wound around the ferromagnetic core and is configured to convert a magnetic signal detected through the pickup coil into an induced voltage and output the induced voltage.

The magnetic sensor may include a first ferromagnetic core, a second ferromagnetic core, a first pickup coil wound around the first ferromagnetic core, and a second pickup coil wound around the second ferromagnetic core, is configured to convert the magnetic signal detected through the first pickup coil into a first induced voltage and output the first induced voltage, and is configured to convert the magnetic signal detected through the second pickup coil into a second induced voltage and output the second induced voltage.

The magnetic signal receiving device may be configured to amplify a difference between the first induced voltage and the second induced voltage using a differential amplifier and restore the original signal using an amplified difference between the first induced voltage and the second induced voltage.

The second pickup coil may be configured to convert the magnetic signal into the second induced voltage having the same magnitude as a magnitude of the first induced voltage and a phase opposite to a phase of the first induced voltage.

The device may further include a matching circuit configured to control a resonant frequency of the magnetic sensor.

Additional aspects of example embodiments will be set forth in part in the description which follows and, in part, will be apparent from the description, or may be learned by practice of the disclosure.

According to various embodiments, a magnetic field communication system and a magnetic signal receiving device may perform extreme environment communication (e.g., underwater and underground) and high sensitivity magnetic field sensing-based wireless transmission in a kilohertz (kHz) frequency band.

According to various embodiments, a magnetic field communication system and a magnetic signal receiving device may include a differential magnetic sensor and a resonant magnetic sensor as magnetic signal receiving elements and may extend a transmission distance.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a schematic block diagram illustrating a magnetic field communication system according to various embodiments;

FIG. 2A is a diagram illustrating a magnetic sensor according to various embodiments;

FIG. 2B is a diagram illustrating an electrical equivalent circuit of the magnetic sensor shown in FIG. 2A;

FIG. 3A is a diagram illustrating a differential magnetic sensor according to various embodiments;

FIG. 3B is a diagram illustrating an electrical equivalent circuit of the differential magnetic sensor shown in FIG. 3A;

FIG. 4 is a diagram illustrating an output voltage characteristic of a differential magnetic sensor according to various embodiments;

FIG. 5 is a diagram illustrating a magnetic noise characteristic of a magnetic sensor and a differential magnetic sensor according to various embodiments;

FIG. 6A is a diagram illustrating a resonant magnetic sensor according to various embodiments;

FIG. 6B is a diagram illustrating S11 features of the resonant magnetic sensor of FIG. 6A;

FIG. 7 is a schematic block diagram illustrating a magnetic signal receiving device including a differential magnetic sensor according to various embodiments;

FIG. 8 is a schematic block diagram illustrating the magnetic signal receiving device including a resonant magnetic sensor according to various embodiments; and

FIG. 9 is a flowchart illustrating a magnetic field communication method performed by a magnetic signal receiving device according to various embodiments.

### DETAILED DESCRIPTION

Hereinafter, embodiments will be described in detail with reference to the accompanying drawings. However, various alterations and modifications may be made to the embodiments. Here, the embodiments are not meant to be limited by the descriptions of the present disclosure. The embodiments should be understood to include all changes, equivalents, and replacements within the idea and the technical scope of the disclosure.

The terminology used herein is for the purpose of describing particular embodiments only and is not intended to be limiting. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

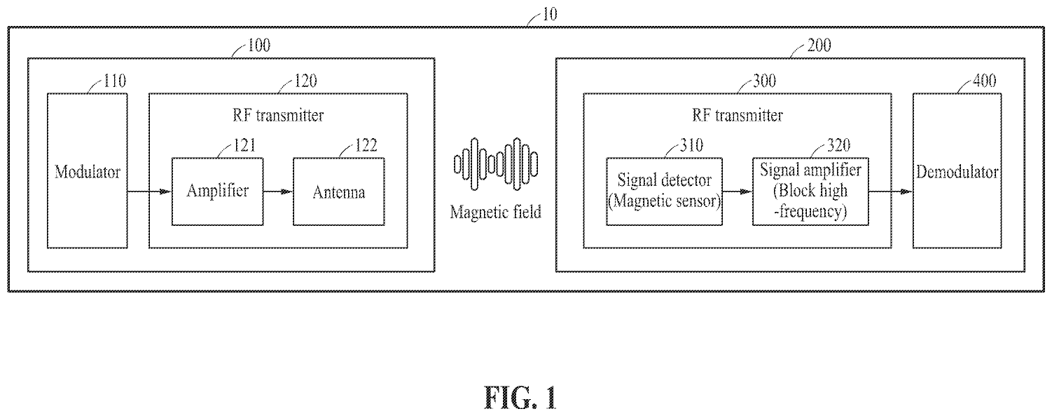

FIG. 1 is a schematic block diagram illustrating a magnetic field communication system 10 according to various embodiments.

Referring to FIG. 1, according to an embodiment, the magnetic field communication system 10 may include a magnetic signal transmission device 100 and a magnetic signal receiving device 200.

The magnetic signal transmission device 100 may modulate an original signal (e.g., a message signal) into a modulated signal and transmit the modulated signal as a magnetic signal.

The magnetic signal receiving device 200 may detect a magnetic signal using a magnetic sensor. The magnetic signal receiving device 200 may output an amplified signal obtained by amplifying the detected magnetic signal. The magnetic signal receiving device 200 may restore an original signal using the amplified signal.

In an example, the magnetic signal transmission device 100 may include a modulator 110 and a radio frequency (RF) transmitter 120. For example, the modulator 110 may modulate a signal to be transmitted (e.g., an original signal, a message signal, a random signal, etc.) and generate a modulated signal. The modulated signal may include a carrier signal hex and a message signal fin. The modulator 110 may generate a modulated signal according to a frequency shift keying (FSK), phase shift keying (PSK), amplitude shift keying (ASK), etc., of a sine wave but is not limited to the described modulation methods and may generate a modulated signal through other modulation methods.

The RF transmitter 120 may include a digital-to-analog converter (DAC), an amplifier 121, and a transmission antenna 122.

The DAC may convert a digital signal of “1” and “0” (e.g., a modulated signal) modulated by the modulator 110 into an analog modulated signal and output the analog modulated signal to the amplifier 121.

The amplifier 121 may amplify and transmit the analog modulated signal received from the DAC to the transmission antenna 122.

The transmission antenna 122 may transmit the amplified analog modulated signal received from the amplifier 121 as a magnetic signal to a space. The transmission antenna 122 may include a loop antenna in which a coil is wound in a circular or rectangular shape.

In an example, the magnetic signal receiving device 200 may include an RF receiver 300 and a demodulator 400. For example, the RF receiver 300 may include a signal detector 310 and a signal amplifier 320.

For example, the signal detector 310 may include a magnetic sensor. The signal detector 310 may detect a magnetic signal using the magnetic sensor. The signal detector 310 may detect and transmit a magnetic signal including a message signal from an external magnetic field to the signal amplifier 320.

The signal amplifier 320 may amplify the magnetic signal detected by the signal detector 310. For example, the signal amplifier 320 may block a high-frequency other than a magnetic signal and amplify the magnetic signal.

The demodulator 400 may restore the amplified magnetic signal received from the signal amplifier 320 to an original signal (e.g., a message signal).

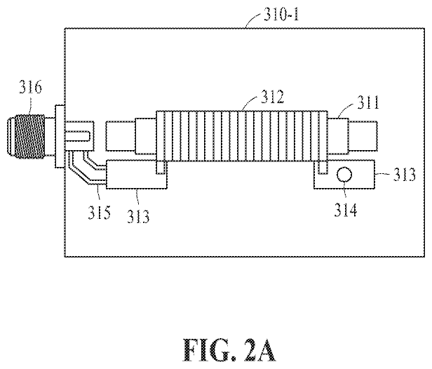

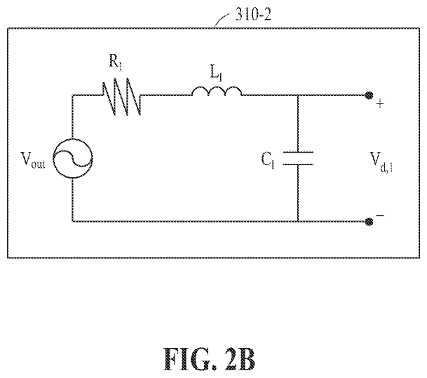

FIG. 2A is a diagram illustrating a magnetic sensor 310-1 according to various embodiments.

Referring to FIG. 2A, according to an embodiment, the magnetic sensor 310-1 may include a ferromagnetic core 311 and a pickup coil 312. For example, the pickup coil 312 may be formed in a form wound around a ferromagnetic core. The pickup coil 312 may be spirally wound around the ferromagnetic core. The magnetic sensor 310-1 may convert a magnetic signal detected through the pickup coil 312 into an induced voltage and output the induced voltage. For example, the magnetic sensor 310-1 shown in FIG. 2A may be understood as substantially the same as an induction sensor.

Referring to FIG. 2A, the magnetic sensor 310-1 may include a printed circuit board (PCB).

The ferromagnetic core 311 may be a ferrite core of soft ferrite. For example, the ferromagnetic core 311 may be a Ni—Zn ferrite core or an Mn—Zn ferrite core and may have a relative permeability of tens to hundreds. Examples of the ferromagnetic core 311 are not limited to the described examples, and various known ferromagnetic cores 311 may be applied to the magnetic sensor 310-1.

For example, the ferromagnetic core 311 may transmit or receive a magnetic signal in or from a certain direction. The ferromagnetic core 311 may be formed in a cylindrical core shape.

The pickup coil 312 may be a wire spirally wound around the ferromagnetic core 311. The start point and the end point of the pickup coil 312 may both be connected to a coil pad 313. As shown in FIG. 2A, the end point of the pickup coil 312 may be connected to ground on the back of the PCB through a via hole 314 of the coil pad 313. The start point of the pickup coil 312 may be connected to a signal output terminal 316 through a signal line 315 connected to the coil pad 313 on the front of the PCB. The signal output terminal 316 may sense an external magnetic signal (e.g., a modulated signal transmitted as a magnetic signal from a magnetic signal transmission device) through the pickup coil 312, convert the sensed external magnetic signal into an induced voltage, and output the induced voltage.

A voltage output of a magnetic signal may be obtained in the signal output terminal 316 as shown in Equation 1 below. For example, Equation 1 may represent the magnitude of an induced voltage output from the magnetic sensor 310-1.

$${v}_{out} = {v}_{d , 1} = - \frac{d ϕ}{dt} = - \frac{NA {μ}_{0} {μ}_{r} dH}{dt} = - \frac{NAdB}{dt} \qquad [ Equation 1 ]$$

In Equation 1, Vₒᵤₜ denotes the magnitude of an induced voltage, N denotes the number of turns of the pickup coil 312, A denotes the diameter of the ferromagnetic core 311, μr denotes relative permeability of the ferromagnetic core 311, and B denotes a magnetic flux density passing through the pickup coil 312.

FIG. 2B is a diagram illustrating an electrical equivalent circuit 310-2 of the magnetic sensor 310-1 shown in FIG. 2A.

Like the magnetic sensor 310-1 shown in FIG. 2A, the magnetic sensor 310-1 in which N-turn pickup coils are wound may be expressed as the electrical equivalent circuit 310-2 shown in FIG. 2B. The electrical equivalent circuit 310-2 of the magnetic sensor 310-1 may be expressed as resistance R₁ of a coil, inductance L₁ of a coil, and parasitic capacitance C₁ between coils.

Using Equation 1, the frequency response characteristic of the electrical equivalent circuit 310-2 shown in FIG. 2B may be expressed as Equation 2 below.

$${v}_{d , 1 ,} = - {v}_{pickup} = - \frac{NA ω B}{( 1 - {ω}^{2} LC ) + j ω RC} \qquad [ Equation 2 ]$$

In Equation 2, L denotes the inductance (e.g., L₁) of a coil, R denotes the resistance (e.g., R₁) of a coil, and C denotes the parasitic capacitance (e.g., C₁) between coils.

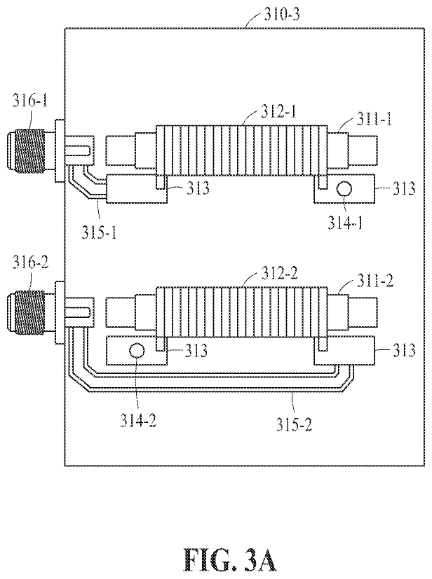

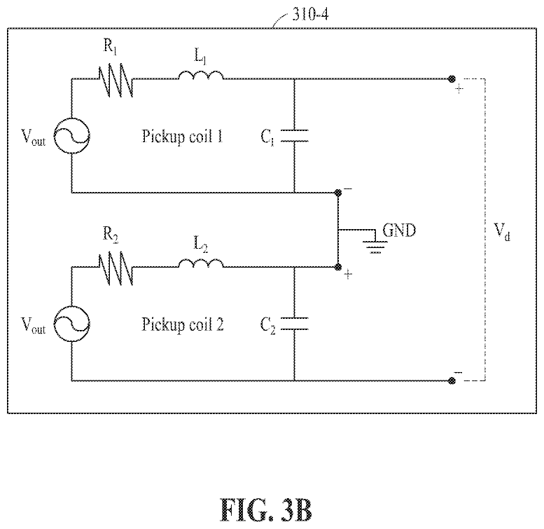

FIG. 3A is a diagram illustrating a differential magnetic sensor 310-3 according to various embodiments.

Referring to FIG. 3A, the differential magnetic sensor 310-3 may include a first ferromagnetic core 311-1, a second ferromagnetic core 311-2, a first pickup coil 312-1, and a second pickup coil 312-2. The first pickup coil 312-1 may be formed by being wound around the first ferromagnetic core 311-1 and the second pickup coil 312-2 may be formed by being wound around the second ferromagnetic core 311-2. The differential magnetic sensor 310-3 may be understood substantially the same as a differential induction sensor. The differential magnetic sensor 310-3 may include a PCB.

The differential magnetic sensor 310-3 may convert a magnetic signal detected through the first pickup coil 312-1 into a first induced voltage and output the first induced voltage. The differential magnetic sensor 310-3 may convert a magnetic signal detected through the second pickup coil 312-2 into a second induced voltage and output the second induced voltage.

The start point of the first pickup coil 312-1 wound around the first ferromagnetic core 311-1 may be connected to a coil pad 313, and then may be connected to a first signal output terminal 316-1 through a first signal line 315-1. The end point of the first pickup coil 312-1 wound around the first ferromagnetic core 311-1 may be connected to ground on the back of the PCB through a first via hole 314-1 of the coil pad 313.

On the other hand, the start point of the second pickup coil 312-2 wound around the second ferromagnetic core 311-2 may be connected to ground on the back of the PCB through a second via hole 314-2 of the coil pad 313. The end point of the second pickup coil 312-2 wound around the second ferromagnetic core 311-2 may be connected to the coil pad 313, and then may be connected to a second signal output terminal 316-2 through a second signal line 315-2.

As shown in FIG. 3A, when the end and start points of the first pickup coil 312-1 and the second pickup coil 312-2 are connected the first via hole 314-1 and the second via hole or the coil pad 313, the differential magnetic sensor 310-3 may sense the same magnetic signal using the first pickup coil 312-1 and the second pickup coil 312-2, but the directions of currents induced by the first pickup coil 312-1 and the second pickup coil 312-2 may be opposite.

The first induced voltage may be output from the first signal output terminal 316-1 by the first pickup coil 312-1. The second induced voltage may be output from the second signal output terminal 316-2 by the second pickup coil 312-2.

The magnitude of the second induced voltage may be the same as that of the first induced voltage. The phase of the second induced voltage may be opposite to that of the first induced voltage. Since the connecting direction of the start point and end point of the second pickup coil 312-2 is opposite to that of the start point and end point of the first pickup coil 312-1, the phase of the second induced voltage may be opposite to that of the first induced voltage.

For example, the signal amplifier 320 may amplify and output the difference between the first induced voltage and the second induced voltage using a differential amplifier. For example, the difference between the first induced voltage and the second induced voltage may be twice as large as the magnitude of the induced voltage by the pickup coil 312 shown in FIG. 2A. For example, as shown in Equation 3 below, a difference V_{d} between the first induced voltage and the second induced voltage may be calculated.

$${v}_{d} = {v}_{pickup 2} - {v}_{pickup 1} = \frac{NAdB}{dt} - ( - \frac{NAdB}{dt} ) = \frac{2 NAdB}{dt} \qquad [ Equation 3 ]$$

In Equation 3, V_{pickup2} denotes the second induced voltage induced by the second pickup coil 312-2 and V_{pickup1} denotes the first induced voltage induced by the first pickup coil 312-1. Referring to Equation 3, the difference V_{d} between the first induced voltage and the second induced voltage may be twice that of Vₒᵤₜ of Equation 1.

FIG. 3B is a diagram illustrating an electrical equivalent circuit 310-4 of the differential magnetic sensor 310-3 shown in FIG. 3A.

As shown in FIG. 3B, the electrical equivalent circuit 310-4 of the differential magnetic sensor 310-3 of FIG. 3A may have a form in which two electrical equivalent circuits 310-2 of FIG. 2B are combined. In FIG. 3B, the frequency response characteristic of an output voltage V_{d} according to the first induced voltage and the second induced voltage may be calculated as shown in Equation 4 below.

$${v}_{d} = {v}_{pickup 2} - {v}_{pickup 1} = \frac{NA ω B}{( 1 - {ω}^{2} LC ) + j ω RC} - ( - \frac{NA ω B}{( 1 - {ω}^{2} LC ) + j ω RC} ) = \frac{2 NA ω B}{( 1 - {ω}^{2} LC ) + j ω RC} \qquad [ Equation 4 ]$$

Referring to Equations 3 and 4, the differential magnetic sensor 310-3 may have an output voltage that is twice that of the magnetic sensor 310-1 of FIG. 2A.

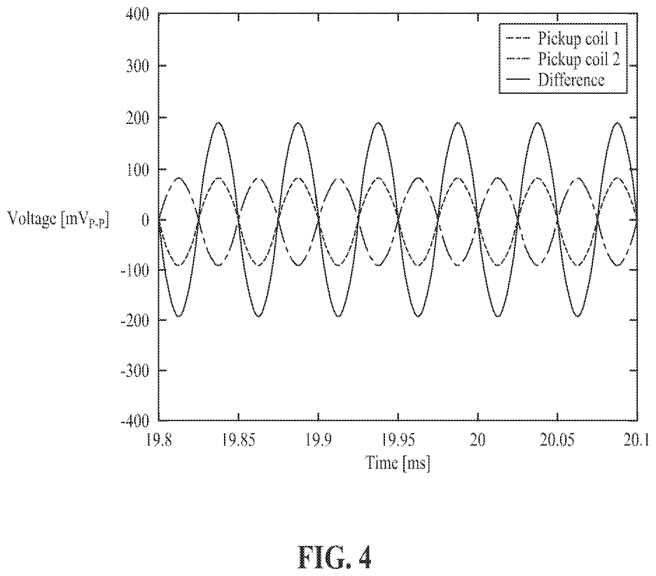

FIG. 4 is a diagram illustrating an output voltage characteristic of the differential magnetic sensor 310-3 according to various embodiments.

The graph shown in FIG. 4 represents an output voltage measured over time for the magnetic sensor 310-1 of FIG. 2A and the differential magnetic sensor 310-3 of FIG. 3A at a carrier frequency of 20 kilohertz (kHz) in a frequency band less than or equal to 100 kHz.

The signal detector 310 may convert a magnetic signal detected using the magnetic sensor 310-1 and the differential magnetic sensor 310-3 into an induced voltage (e.g., pickup coil 1 or pickup coil 2 in FIG. 4) and output the induced voltage.

The signal detector 310 may output the difference between the first induced voltage (e.g., the pickup coil 1) and the second induced voltage (e.g., the pickup coil 2) using the differential magnetic sensor 310-3. For example, the first induced voltage may be converted from a magnetic signal detected by the first pickup coil 312-1. Here, it may be seen that the first induced voltage (e.g., the pickup coil 1) has the same magnitude as that of the induced voltage output from the pickup coil 312 of the magnetic sensor 310-1 in FIG. 2A. The second induced voltage may be converted from a magnetic signal detected by the second pickup coil 312-2. The signal amplifier 320 may amplify the difference between the first induced voltage and the second induced voltage using the differential amplifier.

As shown in FIG. 4, it may be seen that the second induced voltage (e.g., the pickup coil 2) converted from the magnetic signal detected by the second pickup coil 312-2 has a phase difference of 180 degrees from the first induced voltage (e.g., the pickup coil 1) converted from the magnetic signal detected by the first pickup coil 312-1. It may be seen that the magnitude of the second induced voltage is the same as that of the first induced voltage.

As shown in FIG. 4, it may be seen that the magnitude (e.g., the difference between the first induced voltage and the second induced voltage) of the voltage output from the differential magnetic sensor 310-3 is twice the magnitude of the voltage output from the magnetic sensor 310-1.

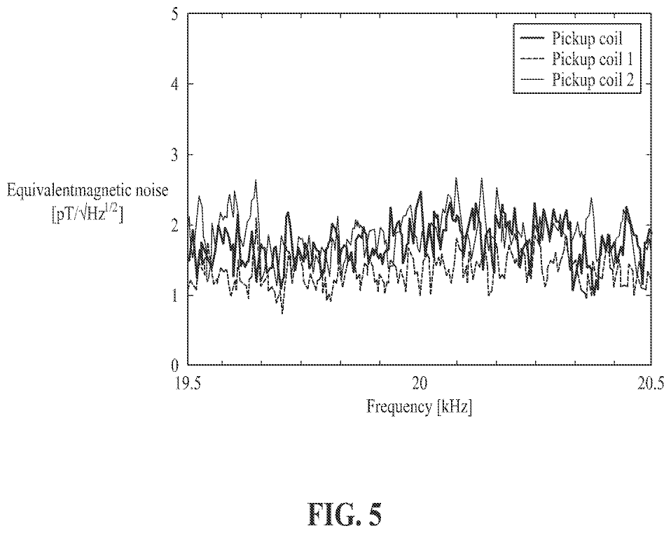

FIG. 5 is a diagram illustrating a magnetic noise characteristic of the magnetic sensor 310-1 and the differential magnetic sensor 310-3 according to various embodiments.

FIG. 5 shows a magnetic noise characteristic of the magnetic sensor 310-1 of FIG. 2A and the differential magnetic sensor 310-3 of FIG. 3A and it may be seen that both magnetic sensors have high sensitivity characteristics of about 2 pT/Hz^{1/2}.

According to the voltage characteristic and magnetic noise characteristic of the differential magnetic sensor 310-3 described with reference to FIGS. 4 and 5, the differential magnetic sensor 310-3 may have a high sensitivity characteristic of a pico-tesla level, a high signal-to-noise ratio (SNR), and a high common-mode rejection ratio (CMRR) and may increase a magnetic field communication distance by detecting a weak magnetic signal.

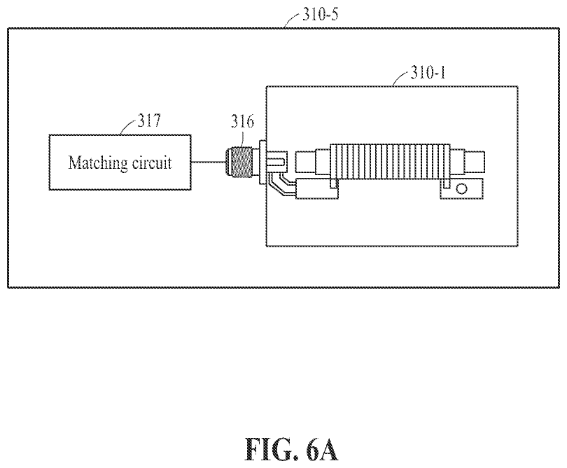

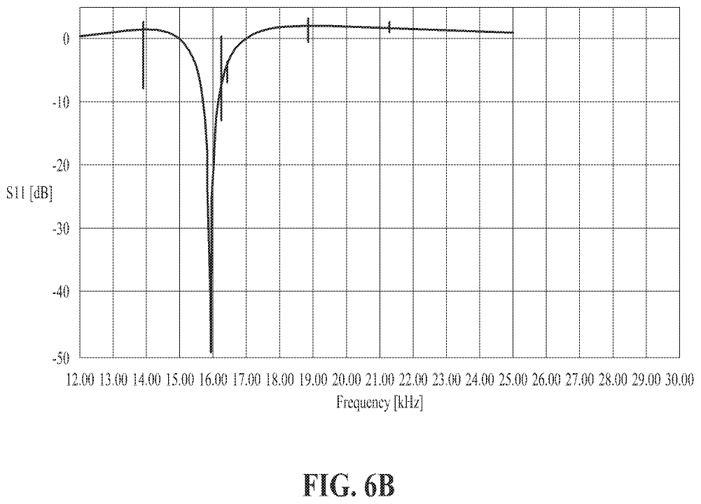

FIG. 6A is a diagram illustrating a resonant magnetic sensor 310-5 according to various embodiments.

Even though the descriptions are not provided with respect to FIG. 6A, the descriptions provided with reference to FIGS. 2A and 2B may identically apply to the descriptions of FIG. 6A. As shown in FIG. 6A, the resonant magnetic sensor 310-5 may include the magnetic sensor 310-1 and a matching circuit 317.

Referring to FIG. 6A, according to an embodiment, the magnetic signal receiving device 200 may further include the matching circuit 317 to control a resonant frequency of the magnetic sensor 310-1.

In the resonant magnetic sensor 310-5, the matching circuit 317 may be connected to the magnetic sensor 310-1. The magnetic sensor 310-1 may be formed by winding the pickup coil 312 around the ferromagnetic core 311 and may thus operate as an inductance component L such as an inductor. For example, when the matching circuit 317 is implemented with capacitance C, the magnetic sensor 310-1 may be implemented as a magnetic sensor in the form of series resonance such as resonance of an antenna. A resonant frequency f₀ may be calculated using Equation 5.

$${f}_{0} = \frac{1}{2 {π ( LC )}^{\frac{1}{2}}} \qquad [ Equation 5 ]$$

In Equation 5, L denotes an inductance component of the magnetic sensor 310-1 and C denotes capacitance of the matching circuit 317.

For example, the magnetic signal receiving device 200 may improve the magnetic signal receiving performance using the resonant magnetic sensor 310-5. For example, the magnetic signal receiving device 200 may control the matching circuit 317 to have the same resonant frequency as the carrier frequency of the magnetic signal transmission device 100.

FIG. 6B is a diagram illustrating S11 features of the resonant magnetic sensor 310-5 of FIG. 6A.

For example, the S11 features are values obtained by solving a signal transmission from port 1 (e.g., an input port) to port 1 in the S parameter with a scattering matrix and may represent return loss.

FIG. 6B may show the S11 features for series resonance of the resonant magnetic sensor 310-5 of FIG. 6A. Referring to FIG. 6B, at 16 kHz, the resonant frequency of the resonant magnetic sensor 310-5 may be the same resonant frequency as a frequency (e.g., a carrier frequency) of a magnetic signal transmitted from the magnetic signal transmission device 100.

As shown in FIGS. 6A and 6B, when the resonant frequency of the resonant magnetic sensor 310-5 is resonated to be the same resonant frequency as the frequency (e.g., the carrier frequency) of the magnetic signal transmitted from the magnetic signal transmission device 100 using the matching circuit 317, the magnetic signal receiving device 200 may improve the gain and/or sensitivity of the received magnetic signal. The magnetic signal receiving device 200 may improve a magnetic field communication distance using the resonant magnetic sensor 310-5 that may improve the gain and/or sensitivity of the received magnetic signal.

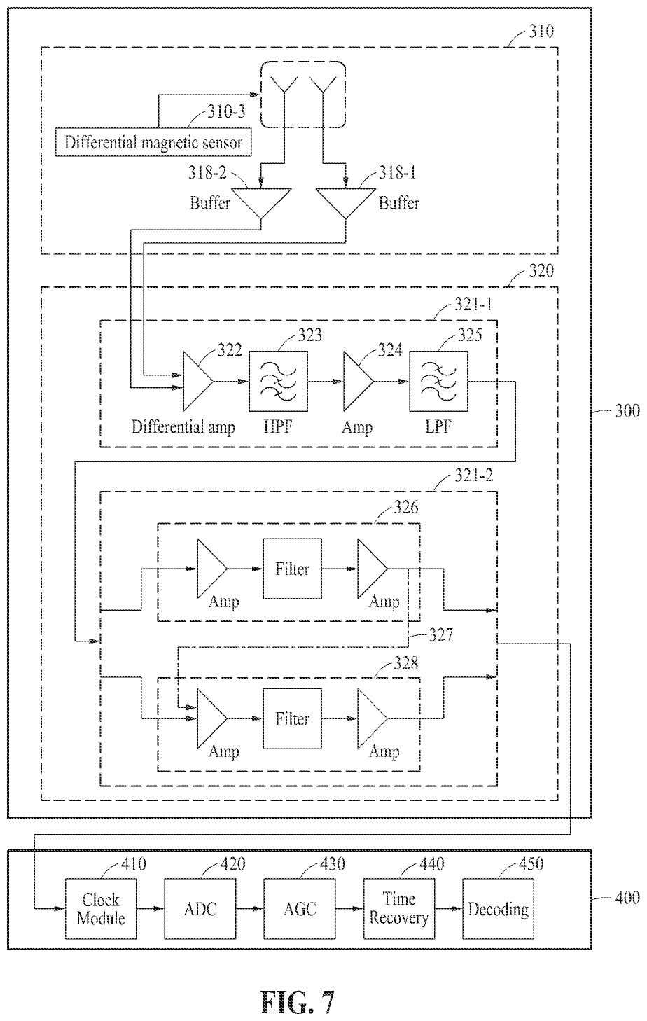

FIG. 7 is a schematic block diagram illustrating the magnetic signal receiving device 200 including the differential magnetic sensor 310-3 according to various embodiments.

Referring to FIG. 7, according to various embodiments, the magnetic signal receiving device 200 may include the RF receiver 300 and the demodulator 400.

The RF receiver 300 may include the signal detector 310 and the signal amplifier 320.

The signal detector 310 may convert a detected magnetic signal into a first induced voltage and a second induced voltage using the differential magnetic sensor 310-3.

The signal detector 310 may include the differential magnetic sensor 310-3 and two voltage buffers 318-1 and 318-2. A combination of the differential magnetic sensor 310-3 and the voltage buffers 318-1 and 318-2 of the signal detector 310 may detect an external magnetic signal (e.g., an analog modulated signal (ωₑₓ+fₘ) and a signal combining a carrier frequency with a message signal signal) and output the first induced voltage and the second induced voltage. For example, the signal detector 310 may convert the detected magnetic signal the first induced voltage and the second induced voltage the first induced voltage and the second induced voltage and output the first induced voltage and the second induced voltage to the signal amplifier 320.

The signal detector 310 may output the external magnetic signal received from the differential magnetic sensor 310-3 to the signal amplifier 320 using the voltage buffers 318-1 and 318-2. The voltage buffers 318-1 and 318-2 may set input impedance greater than or equal to kΩ and may set output impedance to 50Ω. The impedance mismatch may be minimized using the input impedance and output impedance of the voltage buffers 318-1 and 318-2.

The voltage buffers 318-1 and 318-2 may each operate as a type of transformer. The signal detector 310 may output the first induced voltage and the second induced voltage to the signal amplifier 320 by minimizing the loss of the received magnetic signal using the voltage buffers 318-1 and 318-2.

The signal amplifier 320 may output an amplified signal obtained by amplifying the difference between the first induced voltage and the second induced voltage using a differential amplifier 322. The signal amplifier 320 may block frequencies other than a magnetic signal received from the signal detector 310 and amplify the received magnetic signal. For example, the received magnetic signal may be understood as substantially the same as the first induced voltage and the second induced voltage output from the signal detector 310.

The signal amplifier 320 may include a first signal amplifier 321-1 and a second signal amplifier 321-2. The first signal amplifier 321-1 may include the differential amplifier 322, a high-pass filter 323, an amplifier 324, and a low-pass filter 325. The second signal amplifier 321-2 may include a third signal amplifier 326 and a fourth signal amplifier 328.

The differential amplifier 322 of the first signal amplifier 321-1 may receive and integrate two independent magnetic signals (e.g., the first induced voltage and the second induced voltage) output from the signal detector 310, and then output one magnetic signal (e.g., the difference between the first induced voltage and the second induced voltage) to the high-pass filter 323. For example, the differential amplifier 322 may amplify and output the difference between the first induced voltage and the second induced voltage.

The magnitude of the voltage of one magnetic signal integrated by the differential amplifier 322 may be twice the magnitude of the voltage output from the magnetic sensor 310-1 in FIG. 2A. The first signal amplifier 321-1 may amplify a signal output from the differential amplifier 322 by N times, remove direct current (DC) components, and output a magnetic signal to the high-pass filter 323 by increasing the SNR of the magnetic signal through the high CMRR.

Using the high-pass filter 323 the first signal amplifier 321-1 may filter (e.g., block a low-frequency band) a signal band lower than the magnetic signal from the magnetic signal amplified. The first signal amplifier 321-1 may amplify the magnetic signal output from the high-pass filter 323 by N times using the amplifier 324 and output the amplified magnetic signal to the low-pass filter 325.

The first signal amplifier 321-1 may, using the low-pass filter 325, filter (e.g., block a high-frequency band) a signal band higher than the magnetic signal from the magnetic signal output from the amplifier 324 and output the magnetic signal to the second signal amplifier 321-2.

The second signal amplifier 321-2 may amplify a signal output from the first signal amplifier 321-1 and output the amplified signal. The second signal amplifier 321-2 may transmit the amplified signal to the demodulator 400.

The third signal amplifier 326 may include an input terminal N-times amplifier, a filter, and an output terminal N-times amplifier. A low-pass filter, a band-pass filter, a high-pass filter, or a band-block filter may be selectively applied to the filter of the third signal amplifier 326 according to necessity or circumstances. In addition, the filter may filter up to the unit of Hz, so that frequencies adjacent to the carrier frequency of a magnetic signal other than the magnetic signal is filtered. That is, it is possible to filter unnecessary signal bands up to a little narrow band adjacent to the carrier frequency and remove unnecessary noise and unnecessary signals other than the magnetic signal.

The third signal amplifier 326 may remove surrounding environmental noise and unnecessary signals by filtering all adjacent frequency bands of the magnetic signal and may thus have significant advantages to restore the magnetic signal from hundreds of meters away by increasing a communication possible distance of the magnetic field communication system 10 to hundreds of meters.

For example, the fourth signal amplifier 328 may include the same configuration (e.g., the input terminal N-times amplifier, the filter, and the output terminal N-times amplifier) as that of the third signal amplifier 326.

For example, the output terminal of the third signal amplifier 326 may be connected to the input terminal of the fourth signal amplifier 328 through a cascade 327. When the third signal amplifier 326 and the fourth signal amplifier 328 are cascaded (e.g., an input terminal of the third signal amplifier 326-an output terminal of the third signal amplifier 326-an input terminal of the fourth signal amplifier 328-an output terminal of the fourth signal amplifier 328), the input terminal of the third signal amplifier 326 and the output terminal of the fourth signal amplifier 328 may be connected.

When the third signal amplifier 326 and the fourth signal amplifier 328 are cascaded, the magnetic signal receiving device 200 may include a hybrid combination of various filters according to the filter of the third signal amplifier 326 and the filter of the fourth signal amplifier 328.

For example, when the filter of the third signal amplifier 326 includes a low-pass filter and the filter of the fourth signal amplifier 328 includes a high-pass filter, the magnetic signal receiving device 200 may process a signal like including a band-pass filter according to the low-pass filter and the high-pass filter. The magnetic signal receiving device 200 may include a combination of the filter of the third signal amplifier 326 and the filter of the fourth signal amplifier 328 in addition to the filter combination as described above.

The second signal amplifier 321-2 may transmit an output magnetic signal (e.g., an amplified signal) to the demodulator 400.

The demodulator 400 may extract and restore a message signal using an amplified signal. The demodulator 400 may receive a magnetic signal, extract the message signal, and decode and restore the message signal.

In an example, the demodulator 400 may include a clock module 410, an analog-to-digital converter (ADC) 420, an auto gain controller (AGC) 430, a time recovery device 440, and a decoder 450.

For example, the clock module 410 may remove the carrier signal ωₑₓ from the magnetic signal ωₑₓ+fₘ, and extract and output a message signal fₘ.

The ADC 420 may convert a message signal, which is an analog signal, into a message signal, which is a digital signal, and output the message signal to the AGC 430.

The AGC 430 may adjust the amplitude of the message signal to maintain a constant output level of a successive message signal.

The time recovery device 440 may perform time recovery to adjust the time of the successive message signal.

The decoder 450 may perform decoding on the message signal and check for an error to restore the message signal (e.g., the original signal).

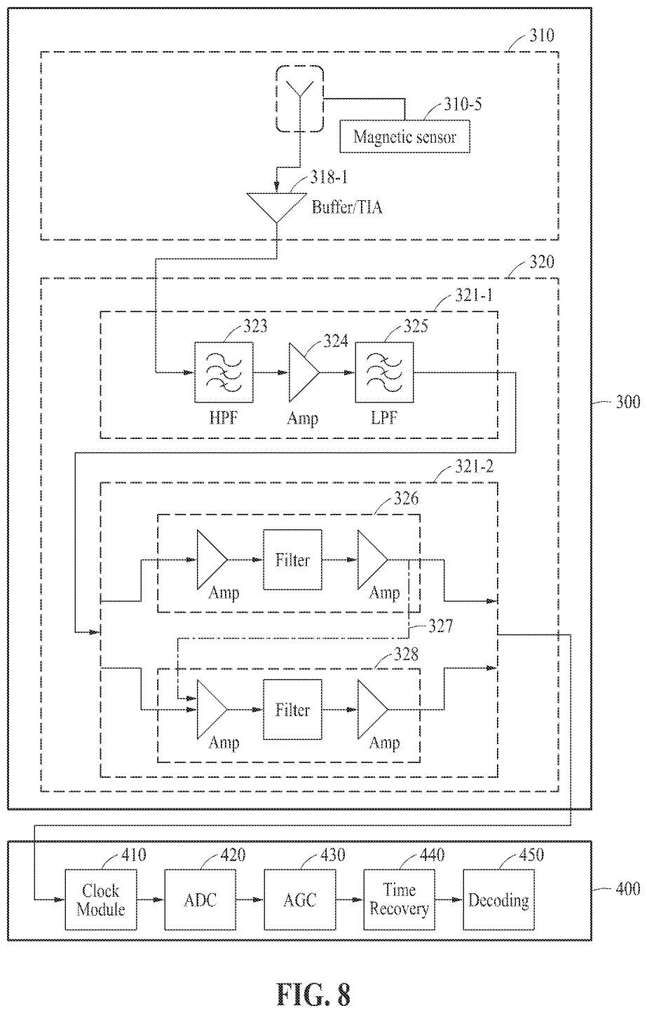

FIG. 8 is a schematic block diagram illustrating the magnetic signal receiving device 200 including the resonant magnetic sensor 310-5 according to various embodiments. Regarding the magnetic signal receiving device 200 shown in FIG. 8, the descriptions of the magnetic signal receiving device 200 shown in FIG. 7 may be omitted. Even if the descriptions of the magnetic signal receiving device 200 provided with reference to FIG. 8 are omitted, the descriptions of the magnetic signal receiving device 200 provided with reference to FIG. 7 may be applied substantially the same in FIG. 8.

Referring to FIG. 8, according to various embodiments, the magnetic signal receiving device 200 may include the RF receiver 300 and the demodulator 400.

The RF receiver 300 may include the signal detector 310 and the signal amplifier 320.

Referring to FIG. 8, the signal detector 310 may include the resonant magnetic sensor 310-5 and one voltage buffer 318-1 or a transimpedance amplifier (TIA) 318-1. Since a magnetic signal detected by the resonant magnetic sensor 310-5 is converted into an induced voltage through the voltage buffer 318-1 or the resonant magnetic sensor 310-5 operates like an antenna (e.g., current sensing), the magnetic signal may be converted into an induced current through the TIA 318-1. The TIA 318-1 may convert a current into voltage and have the same role as the voltage buffer 318-1 described above.

The signal amplifier 320 may include the first signal amplifier 321-1 and the second signal amplifier 321-2. An amplified signal output from the signal amplifier 320 may be transmitted to the demodulator 400. The demodulator 400 may restore the original signal (e.g., a message signal) using the amplified signal.

Referring to FIGS. 7 and 8, depending on whether the magnetic signal receiving device 200 includes the differential magnetic sensor 310-3 or includes the resonant magnetic sensor 310-5, a part of configurations of the magnetic signal receiving device 200 may be changed (e.g., a voltage buffer of the signal detector 310, the presence or absence of the differential amplifier 322 of the first signal amplifier 321-1, etc.).

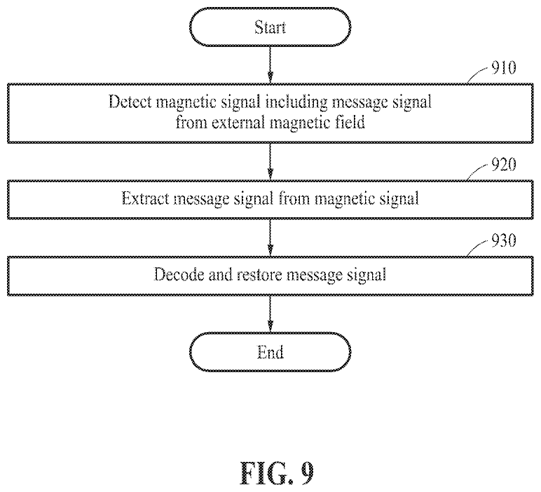

FIG. 9 is a flowchart illustrating a magnetic field communication method performed by the magnetic signal receiving device 200 according to various embodiments.

The magnetic signal receiving device 200 may perform operation 910 of detecting a magnetic signal including a message signal from an external magnetic field in the magnetic field communication system 10, operation 920 of extracting the message signal from the magnetic signal, and operation 930 of decoding and restoring the message signal.

For example, a magnetic signal may be a signal in which the message signal is combined with a carrier signal having a frequency less than or equal to 130 kHz. A modulator of the magnetic signal transmission device 100 may modulate the original signal (or a message signal) into a modulated signal and transmit a magnetic signal to the magnetic signal receiving device 200 using an RF antenna.

In operation 910, the magnetic signal receiving device 200 may detect a magnetic signal from an external magnetic field. For example, the magnetic signal receiving device 200 may detect a magnetic signal using the magnetic sensor 310-1, the differential magnetic sensor 310-3, or the resonant magnetic sensor 310-5. The magnetic signal receiving device 200 may receive a magnetic signal and minimize the loss of the magnetic signal.

In operation 920, the magnetic signal receiving device 200 may extract a message signal from a magnetic signal. For example, the magnetic signal receiving device 200 may amplify the magnetic signal and filter (e.g., remove a low-frequency band and a high-frequency band) the amplified magnetic signal.

The magnetic signal receiving device 200 may remove unnecessary noise and unnecessary signals other than a magnetic signal by filtering up to an adjacent frequency band around a carrier wave of the magnetic signal other than the magnetic signal.

For example, the magnetic signal receiving device 200 may remove noise (e.g., DC components) of a message signal. The magnetic signal receiving device 200 may filter (e.g., remove a high-frequency band) the message signal from which the DC components are removed. The magnetic signal receiving device 200 may amplify the filtered message signal. In addition, the magnetic signal receiving device 200 may convert the amplified message signal into a digital signal.

In operation 930, the magnetic signal receiving device 200 may decode and restore a message signal. For example, the magnetic signal receiving device 200 may extract the message signal by removing a carrier signal from a magnetic signal. The magnetic signal receiving device 200 may convert the message signal into a digital signal and decode the digital signal. The magnetic signal receiving device 200 may check for an error and restore the message signal.

The components described in the example embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to embodiments may be written in a computer-executable program and may be implemented as various recording media such as magnetic storage media, optical reading media, or digital storage media.

Various techniques described herein may be implemented in digital electronic circuitry, computer hardware, firmware, software, or combinations thereof. The implementations may be achieved as a computer program product, for example, a computer program tangibly embodied in a machine readable storage device (a computer-readable medium) to process the operations of a data processing device, for example, a programmable processor, a computer, or a plurality of computers or to control the operations. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor will receive instructions and data from a read-only memory (ROM) or a random access memory (RAM), or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Examples of information carriers suitable for embodying computer program instructions and data include semiconductor memory devices, for example, magnetic media such as hard disks, floppy disks, and magnetic tape, optical media such as compact disc ROMs (CD-ROMs) or digital versatile discs (DVDs), magneto-optical media such as floptical disks, ROMs, RAMs, flash memories, erasable programmable ROMs (EPROMs), or electrically erasable programmable ROMs (EEPROMs). The processor and the memory may be supplemented by, or incorporated in special purpose logic circuitry.

In addition, non-transitory computer-readable media may be any available media that may be accessed by a computer and may include both computer storage media and transmission media.

Although the present specification includes details of a plurality of specific embodiments, the details should not be construed as limiting any invention or a scope that can be claimed, but rather should be construed as being descriptions of features that may be peculiar to specific embodiments of specific inventions. Specific features described in the present specification in the context of individual embodiments may be combined and implemented in a single embodiment. On the contrary, various features described in the context of a single embodiment may be implemented in a plurality of embodiments individually or in any appropriate sub-combination. Moreover, although features may be described above as acting in specific combinations and even initially claimed as such, one or more features from a claimed combination can in some cases be excised from the combination, and the claimed combination may be changed to a sub-combination or a modification of a sub-combination.

Likewise, although operations are depicted in a predetermined order in the drawings, it should not be construed that the operations need to be performed sequentially or in the predetermined order, which is illustrated to obtain a desirable result, or that all of the shown operations need to be performed. In specific cases, multi-tasking and parallel processing may be advantageous. In addition, it should not be construed that the separation of various device components of the aforementioned embodiments is required in all types of embodiments, and it should be understood that the described program components and devices are generally integrated as a single software product or packaged into a multiple-software product.

The embodiments disclosed in the present specification and the drawings are intended merely to present specific examples in order to aid in understanding of the present disclosure, but are not intended to limit the scope of the present disclosure. It will be apparent to those skilled in the art that various modifications based on the technical spirit of the present disclosure, as well as the disclosed example embodiments, can be made.

What is claimed is:

1. A device for receiving a magnetic signal, the device comprising:
a signal detector comprising a magnetic sensor and configured to detect a magnetic signal using the magnetic sensor;
a signal amplifier configured to amplify the magnetic signal detected by the signal detector; and
a demodulator configured to restore the amplified magnetic signal received from the signal amplifier into an original signal.

2. The device of claim 1, wherein the magnetic sensor comprises a ferromagnetic core and a pickup coil wound around the ferromagnetic core and is configured to convert a magnetic signal detected through the pickup coil into an induced voltage and output the induced voltage.

3. The device of claim 1, wherein the magnetic sensor comprises a first ferromagnetic core, a second ferromagnetic core, a first pickup coil wound around the first ferromagnetic core, and a second pickup coil wound around the second ferromagnetic core, is configured to convert the magnetic signal detected through the first pickup coil into a first induced voltage and output the first induced voltage, and is configured to convert the magnetic signal detected through the second pickup coil into a second induced voltage and output the second induced voltage.

4. The device of claim 3, wherein the signal amplifier is configured to amplify and output a difference between the first induced voltage and the second induced voltage using a differential amplifier.

5. The device of claim 3, wherein the second pickup coil is configured to convert the magnetic signal into the second induced voltage having the same magnitude as a magnitude of the first induced voltage and a phase opposite to a phase of the first induced voltage.

6. The device of claim 1, further comprising:
a matching circuit configured to control a resonant frequency of the magnetic sensor.

7. A device for receiving a magnetic signal, the device comprising:
a signal detector configured to convert a magnetic signal detected using a differential magnetic sensor into a first induced voltage and a second induced voltage;
a signal amplifier configured to output an amplified signal obtained by amplifying a difference between the first induced voltage and the second induced voltage using a differential amplifier; and
a demodulator configured to extract and restore a message signal using the amplified signal.

8. The device of claim 7, wherein the differential magnetic sensor comprises a first ferromagnetic core, a second ferromagnetic core, a first pickup coil wound around the first ferromagnetic core, and a second pickup coil wound around the second ferromagnetic core, is configured to convert the magnetic signal detected through the first pickup coil into the first induced voltage and output the first induced voltage, and is configured to convert the magnetic signal detected through the second pickup coil into the second induced voltage and output the second induced voltage.

9. The device of claim 7, wherein the second induced voltage has the same magnitude as a magnitude of the first induced voltage and a phase opposite to a phase of the first induced voltage.

10. The device of claim 7, wherein the signal amplifier comprises:
a first signal amplifier configured to amplify and output the difference between the first induced voltage and the second induced voltage; and
a second signal amplifier configured to amplify a signal output from the first signal amplifier and output the amplified signal.

11. The device of claim 10, wherein the second signal amplifier comprises a third signal amplifier and a fourth signal amplifier each comprising a filter,
wherein the third signal amplifier and the fourth signal amplifier are cascaded.

12. A system for communicating a magnetic field, the system comprising:
a magnetic signal transmission device configured to modulate an original signal into a modulated signal and transmit the modulated signal into a magnetic signal; and
a magnetic signal receiving device configured to detect the magnetic signal using a magnetic sensor, output an amplified signal obtained by amplifying the detected magnetic signal, and restore the original signal using the amplified signal.

13. The system of claim 12, wherein the magnetic signal receiving device comprises:
a signal detector comprising the magnetic sensor and configured to detect the magnetic signal using the magnetic sensor;
a signal amplifier configured to amplify the detected magnetic signal and output the amplified signal; and
a demodulator configured to restore the original signal using the amplified signal.

14. The system of claim 12, wherein the magnetic sensor comprises a ferromagnetic core and a pickup coil wound around the ferromagnetic core and is configured to convert a magnetic signal detected through the pickup coil into an induced voltage and output the induced voltage.

15. The system of claim 12, wherein the magnetic sensor comprises a first ferromagnetic core, a second ferromagnetic core, a first pickup coil wound around the first ferromagnetic core, and a second pickup coil wound around the second ferromagnetic core, is configured to convert the magnetic signal detected through the first pickup coil into a first induced voltage and output the first induced voltage, and is configured to convert the magnetic signal detected through the second pickup coil into a second induced voltage and output the second induced voltage.

16. The system of claim 15, wherein the magnetic signal receiving device is configured to amplify a difference between the first induced voltage and the second induced voltage using a differential amplifier and restore the original signal using an amplified difference between the first induced voltage and the second induced voltage.

17. The system of claim 15, wherein the second pickup coil is configured to convert the magnetic signal into the second induced voltage having the same magnitude as a magnitude of the first induced voltage and a phase opposite to a phase of the first induced voltage.

18. The system of claim 12, wherein the magnetic signal receiving device further comprises a matching circuit configured to control a resonant frequency of the magnetic sensor.
